(19) United States
(12) Patent Application Publication
(10) Pub. No.: US 2025/0334749 A1
(43) Pub. Date: Oct. 30, 2025

(54) ADAPTER

(71) Applicant: Molex, LLC, Lisle, IL (US)

(72) Inventors: Chen-Yu Chen, New Taipei City (TW); Wenzong Chen, Naperville, IL (US); Tung-Min Chen, New Taipei City (TW); Joshua John Krantz, Wheaton, IL (US)

(21) Appl. No.: 19/185,312

(22) Filed: Apr. 22, 2025

(30) Foreign Application Priority Data
Apr. 30, 2024 (CN) 202410540901.3

(51) Int. Cl. G02B 6/38

(52) U.S. Cl. CPC G02B 6/3825; G02B 6/387; G02B 6/3893; G02B 6/3897

(57) ABSTRACT

An adapter includes a housing unit and at least one cover. The housing unit is made of a material which is capable of being conductive and includes an encircling wall. The encircling wall encircles and defines an inserting passageway and an inserting port which are communicated with each other. The inserting passageway and the inserting port are adapted to allow at least one pair of connectors to insert therein. The encircling wall is formed with at least one through hole which is communicated with the inserting passageway. The cover is made of a material which hardness is lower than the housing unit and is provided on the encircling wall of the housing unit. The cover is formed with at least one latching hole which passes through the through hole to be communicated with the inserting passageway. The latching hole is adapted to allow a latching hook of one connector of the at least one pair of connectors to latch therein. The adapter is capable of providing electromagnetic shielding protection while lowering opportunity of abrasion or fracture of the latching hook.

### TECHNICAL FIELD

The present disclosure relates to an adapter and particularly relates to an adapter which is used to configure optical fiber connectors.

### BACKGROUND

In an optical fiber information transmitting system, it often requires a plurality of optical fiber transmitting cables to transfer an optical signal, and completing configuration of the plurality of optical fiber transmitting cables need depend on a plurality of optical fiber connector which are respectively provided on the plurality of optical fiber transmitting cable and an adapter which allow the plurality of optical fiber connectors to insert therein.

The plurality of optical fiber connector each are commonly made of a plastic material, and each optical fiber connector has a latching hook which is used to hook the adapter. Referring to patent document CN 111736272B, it can be seen from description of the prior art of the patent document CN 111736272B, at present, a material of the adapter has two kinds, that is, a metal and a plastic.

An advantage of an adapter which is a metal material is to be capable of providing electromagnetic shielding, but a deficiency of the adapter which is of the metal material lies in that, because a mechanical strength of the metal material is stronger, after the optical fiber connector which is a plastic material is inserted into or pulled out many times from the adapter which is the metal material, the latching hook had by the optical fiber connector which is the plastic material is easily fractured. In comparison with an adapter which is the metal material, an adapter which is a plastic material less easily causes a problem on fracture of the latching hook, but does not have a function of electromagnetic shielding, is not adapted to be applied in a communication rack which requires to provide electromagnetic shielding for use.

From the above, because the adapter which is the metal material and the adapter which is the plastic material respectively have advantages and deficiency thereof, how to provide a solution having both the advantage of the adapter which is the metal material and the advantage of the adapter which is the plastic material is a problem to be solved.

### SUMMARY

An object of the present disclosure is to improve at least one deficiency in the prior art.

An adapter of the present disclosure is adapted to allow at least one pair of connectors to insert therein. At least one of the connectors has a latching hook. The adapter comprises a housing unit and at least one cover. The housing unit is made of a material which is capable of being conductive and encircles and defines an inserting passageway and an inserting port which is communicated with the inserting passageway. The housing unit comprises an encircling wall which encircles and defines the inserting passageway and the inserting port. The inserting passageway and the inserting port are adapted to allow the connector to insert therein. The encircling wall is formed with at least one through hole which is communicated with the inserting passageway. The cover is made of a material which hardness is lower than the housing unit and is engaged on the encircling wall of the housing unit. The cover is formed with at least one latching hole which passes through the through hole to be communicated with the inserting passageway. The latching hole is adapted to allow the latching hook of the connector to latch therewith.

The adapter of the present disclosure is adapted to allow the multiple pairs of connectors to insert therein, the encircling wall of the housing unit is further formed with another inserting port which is communicated with the inserting passageway, the two inserting ports are respectively positioned at two opposite ends of the inserting passageway, the inserting passageway comprises multiple inserting grooves which allow the multiple pairs of connectors to insert therein.

In the adapter of the present disclosure, the encircling wall comprises a top wall portion, an outer surface of the top wall portion which backs the inserting passageway is further recessed to be formed with at least one recessed groove, the recessed groove is communicated with the through hole and allows the cover to be provided on the encircling wall of the housing unit.

In the adapter of the present disclosure, the cover comprises a sheet portion and two latching arms which are provided to two opposite sides of the sheet portion, the inserting passageway penetrates front and rear along an extending direction, the encircling wall comprises two side wall portions which are respectively positioned to two opposite sides of the inserting passageway, each side wall portion is formed with one latch hole, the two latch holes respectively allow the two latching arms to latch therein.

In the adapter of the present disclosure, the encircling wall is formed with the plurality of through holes, the cover comprises a sheet portion and multiple protruding portions which protrude downwardly from the sheet portion, the cover is formed with the multiple latching holes, each latching hole penetrates the respective protruding portion, each protruding portion is positioned in the corresponding through hole.

In the adapter of the present disclosure, the encircling wall has an inner surface which faces the inserting passageway, a lower surface of each protruding portion is flush with the inner surface of the encircling wall.

In the adapter of the present disclosure, the inserting passageway penetrates front and rear along an extending direction, the top wall portion forms an edge which is adjacent to the inserting port, each protruding portion comprises a protruding segment which protrudes along the extending direction, each protruding segment is lower than the sheet portion, the protruding segments are positioned below the edge, the latching hook of the connector only contacts the cover and does not contact the housing unit in a process of inserting into the inserting passageway and in a process of withdrawing out from the inserting passageway.

In the adapter of the present disclosure, the plurality of through holes are divided into two groups which are respectively adjacent to the two inserting ports, the adapter comprises the two covers.

In the adapter of the present disclosure, the housing unit is provided therein with multiple pairs of aligning sleeves which are arranged up and down.

In the adapter of the present disclosure, the housing unit is made of a metal material, the cover is made of a plastic material.

The present disclosure discloses an assembling method of an adapter, the adapter comprises a housing unit and a cover that is less hard than the housing unit, the housing unit is formed with an inserting passageway, a through hole which is communicated with the inserting passageway, and an edge which is adjacent to an inserting port, the cover comprises a protruding portion, the protruding portion comprises a protruding segment, the assembling method comprises: inserting the cover into the corresponding through hole of the housing unit by the protruding segment; and pivoting the cover to make the cover snap into the housing unit and make the protruding segment positioned below the edge.

In the assembling method of the adapter of the present disclosure, pivoting the cover by taking the protruding segment which abuts against the edge as a fulcrum to make the cover snap into the housing unit.

In the assembling method of the adapter of the present disclosure, when the cover snaps into the housing unit, the protruding portion extends into the through hole of the housing unit to provide latching with a latching hook of a connector.

An effect of the present disclosure lies in that, the housing unit is made of a material which is capable of being conductive, and the housing unit is capable of providing electromagnetic shielding protection, and the hardness of the cover which is provided on the housing unit is lower, and the cover is capable of lowering opportunity of abrasion or fracture of the latching hook of each connector when the adapter allows the connectors to insert therein.

### BRIEF DESCRIPTION OF THE DRAWINGS

Other features and effects of the present disclosure will be apparent from embodiments with reference to the drawings, in which:

FIG. 1 is a perspective view illustrating an adapter of a first embodiment of the present disclosure;

FIG. 2 is an exploded perspective view incompletely exploded and illustrating the adapter of the first embodiment of the present disclosure and two connectors;

FIG. 3 is a cross-sectional view illustrating the adapter;

FIG. 4 is an exploded perspective view illustrating the adapter;

FIG. 5 is a side view illustrating the adapter;

FIG. 6 is a perspective view illustrating an assembling process of the adapter;

FIG. 7 is a cross-sectional view illustrating the assembling process of the adapter corresponding to FIG. 6;

FIG. 8 is a cross-sectional view illustrating that the adapter allows one of the two connectors to insert therein;

FIG. 9 is an exploded perspective view incompletely exploded and illustrating an adapter of a second embodiment of the present disclosure and two connectors;

FIG. 10 is an exploded perspective view incompletely exploded and illustrating the adapter;

FIG. 11 is a cross-sectional view illustrating the adapter; and

FIG. 12 is a cross-sectional view illustrating that the adapter allows the two connectors to insert therein.

### DETAILED DESCRIPTION

The similar or same elements are indicated by the same reference numerals in the following described content.

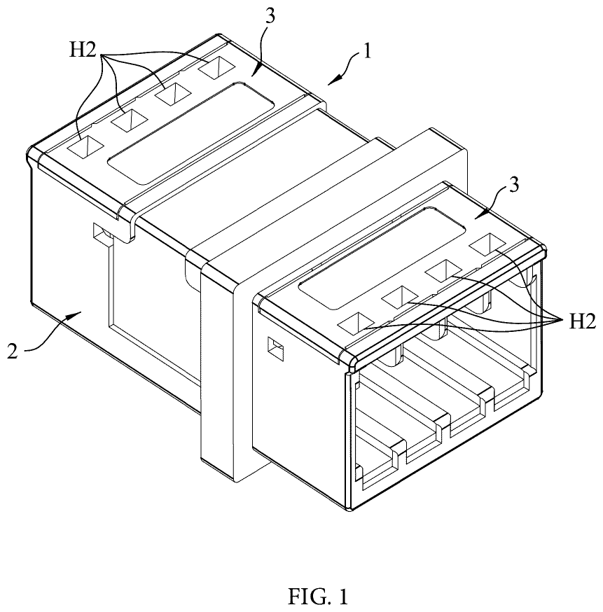

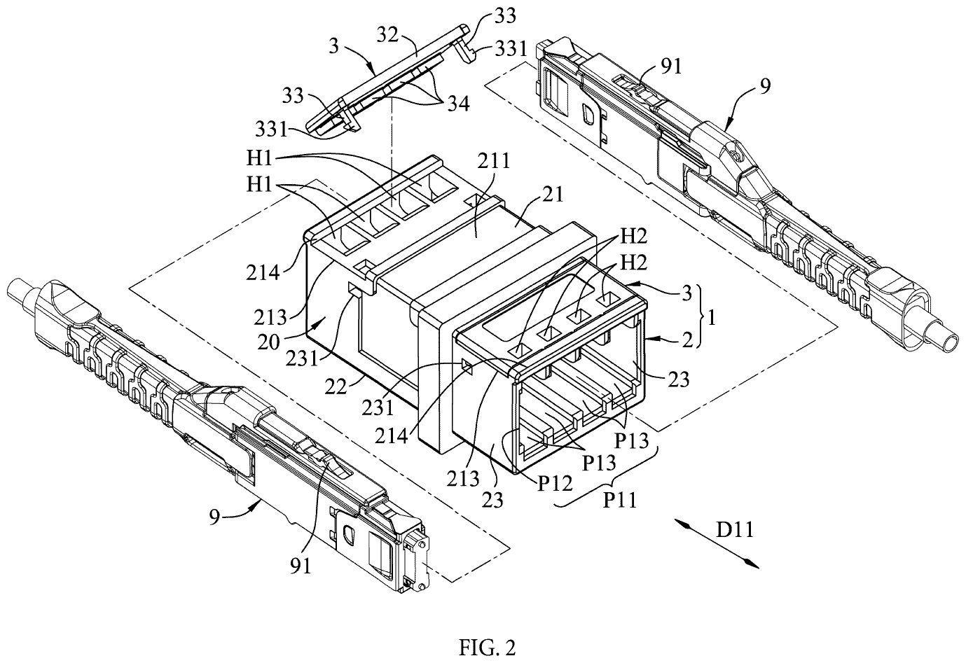

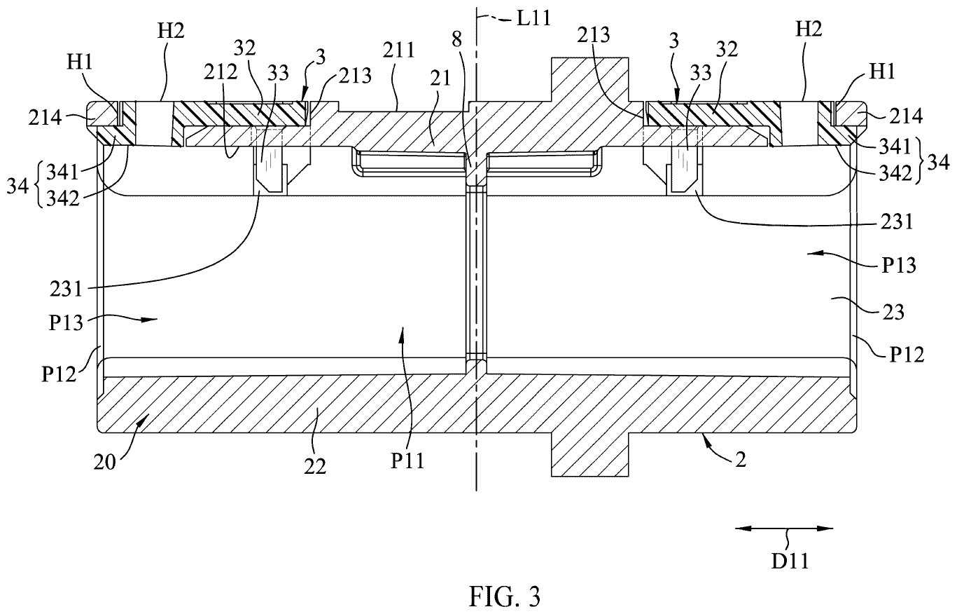

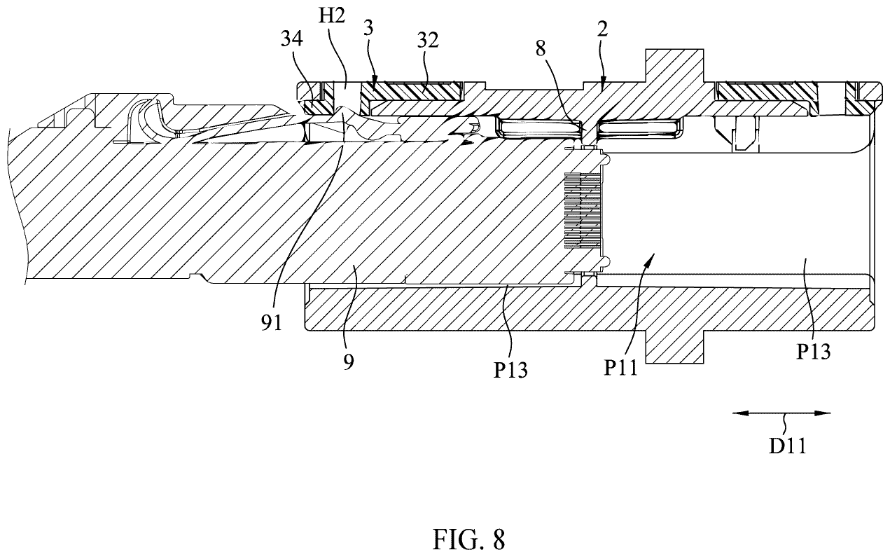

Referring to FIG. 1, FIG. 2 and FIG. 3, in a first embodiment of the present disclosure, the adapter 1 is adapted to configure four pairs connectors 9, that is, the eight connectors 9 (see FIG. 2) for use, the figures only illustrate one pair of connectors 9 which mate with each other. Each connector 9 is an optical fiber connector in which is a MM C type, and a top portion of the connector 9 has a latching hook 91 of a plastic material (see FIG. 2 and supplementarily referring to FIG. 8).

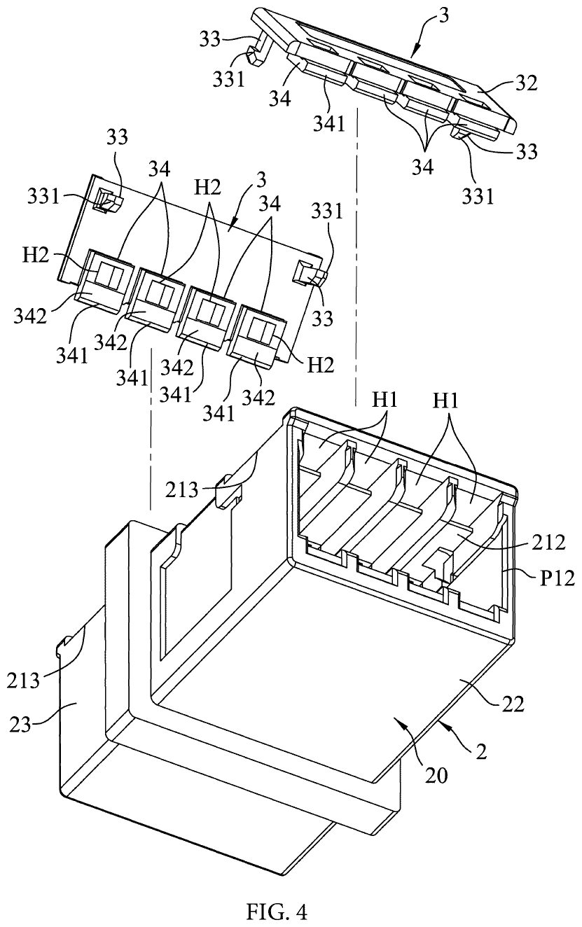

Referring to FIG. 2, FIG. 3 and FIG. 4, the adapter 1 includes a housing unit 2 which is adapted to allow the two connectors 9 to insert therein and two covers 3 which are provided on the housing unit 2 and are adapted to allow the two connectors 9 to latch therewith.

The housing unit 2 includes an encircling wall 20 which encircles and defines an inserting passageway P11. The encircling wall 20 further defines two inserting ports P12 which are respectively communicated with two opposite ends of the inserting passageway P11.

The housing unit 2 is preferably made of a metal material, such as aluminum, steel and the like, which is capable of being conductive, and an outer profile of the housing unit 2 is substantially in form of cuboid shape. The encircling wall 20 includes a top wall portion 21 and a bottom wall portion 22 which are spaced apart from each other up and down (see FIG. 2), and two side wall portions 23 which are spaced apart from each other left and right and are connected between the top wall portion 21 and the bottom wall portion 22.

The top wall portion 21, the bottom wall portion 22 and the two side wall portions 23 cooperate with each other to define the inserting passageway P11. The inserting passageway P11 extends and penetrates along an extending direction D11 which extends front and rear. The inserting passageway P11 includes four inserting grooves P13 which are communicated with the two inserting ports P12. Each inserting groove P13 is adapted to allow the respective connectors 9 to insert therein.

The top wall portion 21 includes an outer surface 211 and an inner surface 212 (see FIG. 3). The outer surface 211 faces upwardly and backs the inserting passageway P11 which is positioned below the outer surface 211, and the outer surface 211 is formed with two recessed grooves 213 which are spaced apart from each other front and rear and are used to allow the two covers 3 to be respectively provided therein. The two recessed grooves 213 are respectively adjacent to the two inserting ports P12. Each recessed groove 213 is in form of rectangular groove shape, and each recessed groove 213 is formed to the top wall portion 21 to make each side of the top wall portion 21 form an edge 214 which is adjacent to the respective inserting port P12.

The top wall portion 21 further is formed with a plurality of through holes H1 which are divided into two groups with each group having the four through holes H1. The through holes H1 of one group and the through holes H1 of the other group are spaced apart from each other front and rear. Each through hole H1 is communicated to the inner surface 212 from the outer surface 211. Each through hole H1 is communicated between the inserting passageway P11 and the respective recessed groove 213. Each through hole H1 is formed to the top wall portion 21 and is substantially in the form of a square hole shape (see FIG. 2). The through holes H1 of each group are communicated with the respective recessed groove 213. Each through hole H1 penetrates the top wall portion 21 up and down to be communicated with one of the four inserting grooves P13 of the inserting passageway P11.

The two side wall portions 23 are respectively positioned to a left side and a right side of the inserting passageway P11. Each side wall portion 23 is formed with two latch holes 231 which are spaced apart from each other front and rear (see FIG. 2). Each latch hole 231 is in form of square hole shape and penetrates left and right to be communicated with the inserting passageway P11.

The two covers 3 are made of a material which hardness is lower than the housing unit 2 and is for example preferably a plastic. The two covers 3 are provided on the top wall portion 21 of the encircling wall 20 of the housing unit 2. Each cover 3 is positioned in the respective recessed groove 213 and includes a plate sheet portion 32 which is in form of rectangular plate shape and extends left and right, two latching arms 33 which respectively connect a left side and a right side of the sheet portion 32, and four protruding portions 34 which protrude downwardly from the sheet portion 32.

Each latching arm 33 includes a hook portion 331 which is positioned to a bottom end of the latching arm 33. Each hook portion 331 protrudes toward a direction which is opposite to the other latching arm 33. Each hook portion 331 hooks to one of the two side wall portions 23 of the housing unit 2 and correspondingly latches into one of the two latch holes 231 of the respective side wall portion 23.

Each protruding portion 34 is in the form of a square annular shape and defines a latching hole H2. Each latching hole H2 is in the form of a square hole shape and is positioned in the respective through hole H1 (see FIG. 3). Each latching hole H2 passes through the corresponding through hole H1 to be communicated with one of the four inserting grooves P13 of the inserting passageway P11. The latching holes H2 are divided into groups which each have four latching holes H2 arranged left and right along a straight line (see FIG. 2). Each latching hole H2 is communicated with one of the two ends of the inserting passageway P11.

Each protruding portion 34 further includes a protruding segment 341 which protrudes out of the sheet portion 32 along the extending direction D11 and a lower surface 342 which is positioned to a bottom of the protruding segment 341. Each protruding segment 341 is lower than a bottom surface of the sheet portion 32, and correspondingly abuts against below the edge 214. Each lower surface 342 is flush with a part of the inner surface 212 of the top wall portion 21 of the housing unit 2 (is the same as the part of the inner surface 212 of the top wall portion 21 of the housing unit in height, see FIG. 3). Together, referring to FIG. 3 and FIG. 8, when the connector 9 inserts into the inserting passageway P11 of the housing unit 2, a latching hook 91 of a connector 9 firstly abuts against and contacts the protruding portion 34 of the cover 3 and in turn then latches into the latching hole H2 of the cover 3. When the connector 9 withdraws out from the inserting passageway P11 of the housing unit 2, the latching hook 91 of the connector 9 firstly withdraws out from the latching hole H2 of the cover 3 and then abuts against and contacts the protruding portion 34 of the cover 3. Because the latching hook 91 of the connector 9 only contacts the cover 3 having a softer material and does not contact the housing unit 2 having a harder material in a process of inserting into the inserting passageway P11 and in a process of withdrawing out from the inserting passageway P11, the latching hook 91 can be better protected.

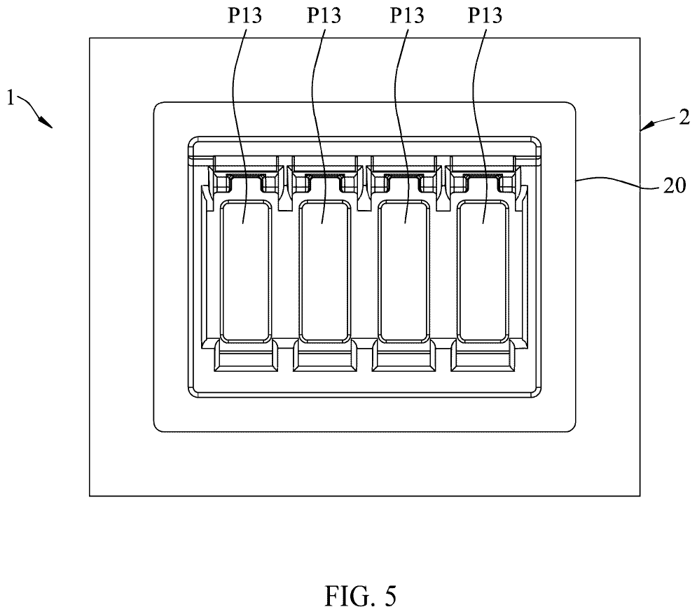

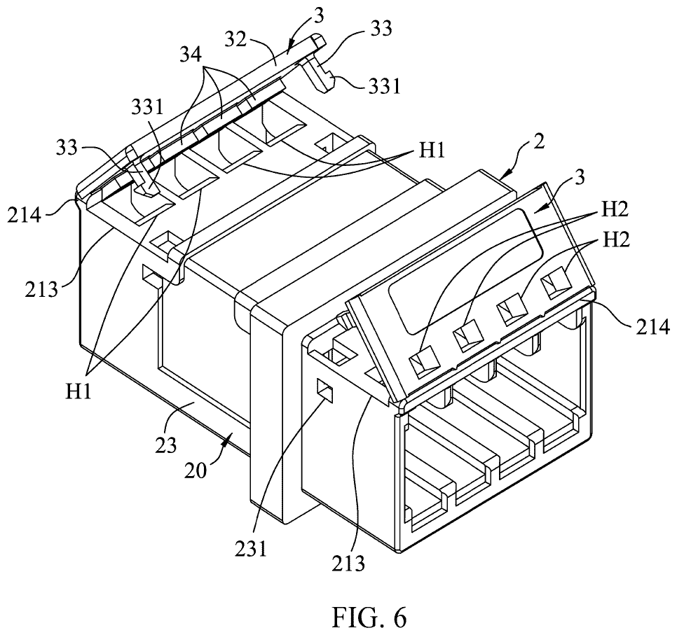

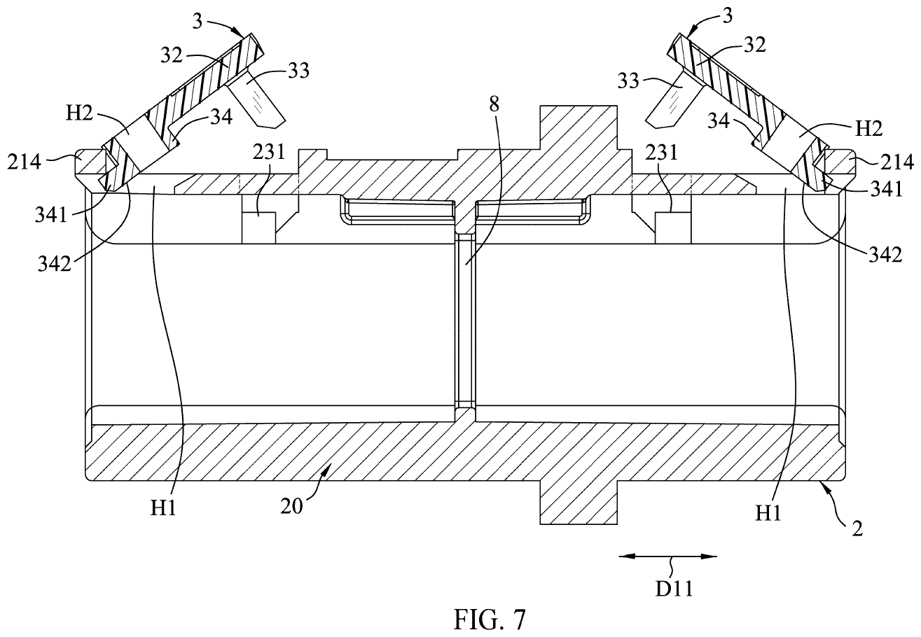

Referring to FIG. 1, FIG. 5, FIG. 6 and FIG. 7, because the housing unit 2 is the metal material, and the two covers 3 are the plastic material, when the adapter 1 is produced, the housing unit 2 and the two covers 3 are firstly manufactured respectively and then are assembled together. When assembled, each cover 3 firstly makes the four protruding segments 341 of the four protruding portions 34 insert into the corresponding through holes H1. Next, each cover 3 pivots downwardly by taking the four protruding segments 341 which abut against one corresponding edge 214 as a fulcrum as shown in FIG. 7, changes from FIG. 7 to cover the top wall portion 21 as shown in FIG. 3, and makes the hook portion 331 of each latching arm 33 latch into the corresponding latch hole 231 of the housing unit 2, so that an assembling of the housing unit 2 and the two covers 3 is completed.

Referring to FIG. 2 and FIG. 8, because each end of the inserting passageway P11 includes the four inserting grooves P13, the adapter 1 can allow the four pairs of connectors 9 (that is, the eight connectors 9) to insert therein at the same time. Here, one of each pair of connectors 9 which is a male type inserts into the inserting passageway P11 from one end of the inserting passageway P11 and then extends beyond a middle partitioning wall 8 of the inserting passageway P11, as shown in FIG. 8, and the other (not shown) of each pair of connectors 9 which is a female type will insert into the inserting passageway P11 from the other end of the inserting passageway P11 to mate with the one of each pair of connectors 9 which is the male type. Although the first embodiment is described as the adapter 1 which may allow the four pairs of connectors 9 to insert therein at the same time, in embodiments not shown, the adapter 1 also may be designed to allow one pair, two pairs or six pairs of connectors 9 to insert therein.

Here, when each connector 9 inserts into one corresponding inserting groove P13, the latching hook 91 of each connector 9 latches into one of the latching holes H2 of the cover 3, as shown in FIG. 8. Characterization of the first embodiment lies in that: because the material of each cover 3 is a plastic, a hardness of each cover 3 is close to a hardness of each latching hook 91, so each connector 9 is inserted into or pulled out from the adapter 1, the cover 3 less easily damages the latching hook 91, so that opportunity of fracture of the latching hook 91 may be lowered. In addition, because the housing unit 2 is made of the metal material, when the housing unit 2 is mounted in a communication rack (not shown), the housing unit 2 may provide an electromagnetic shielding protection.

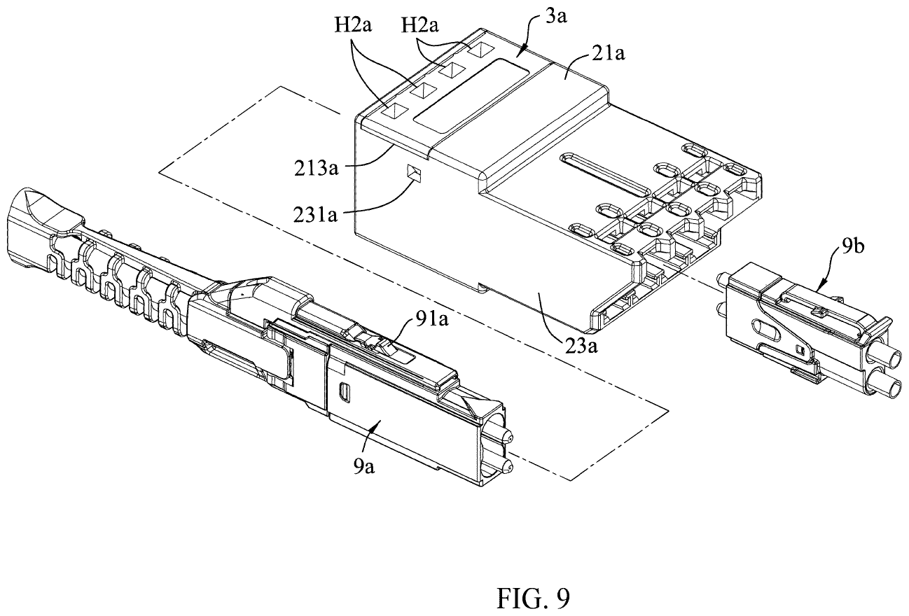

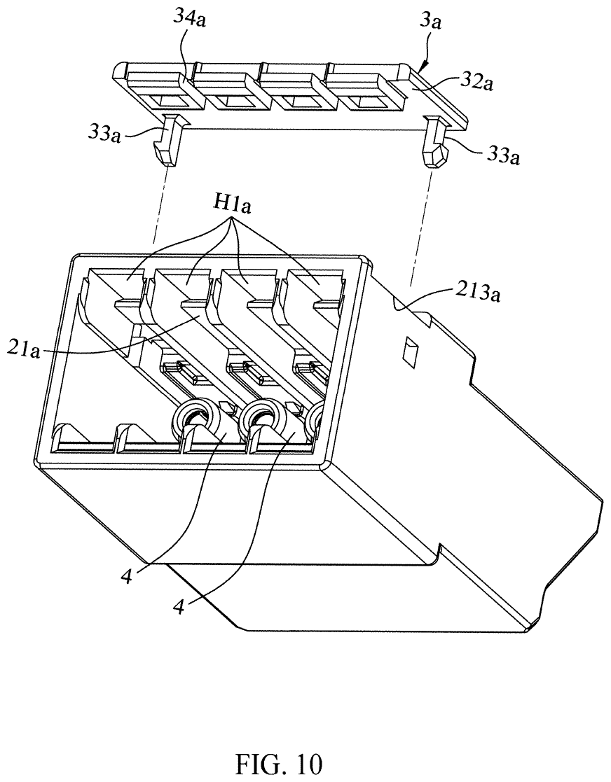

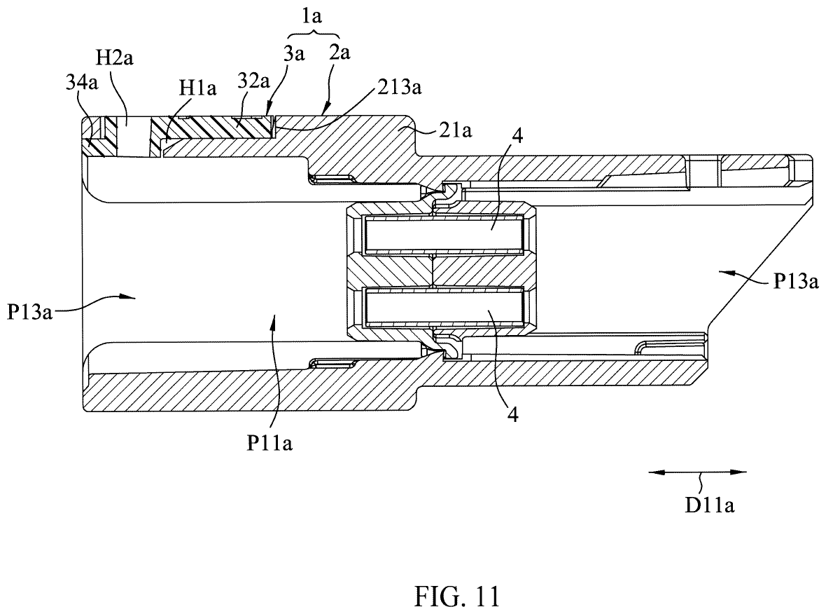

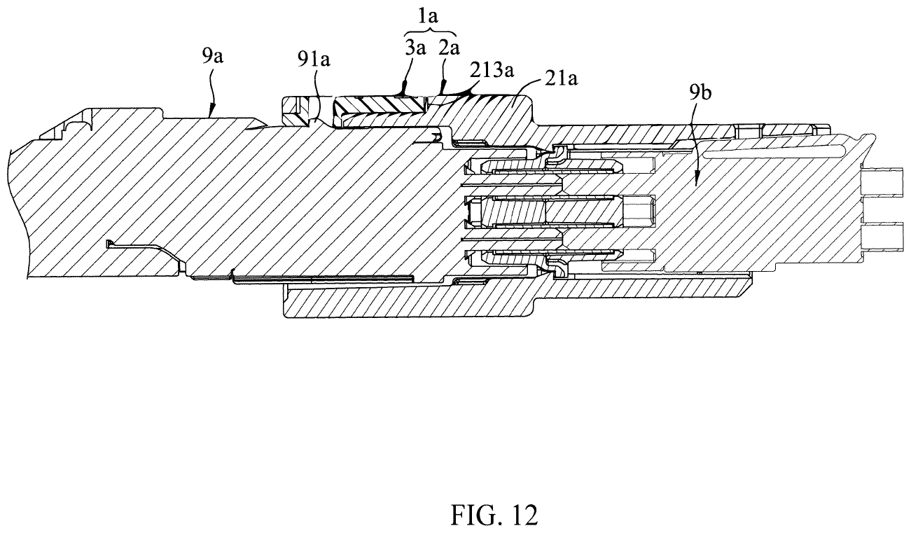

Referring to FIG. 9, FIG. 10, FIG. 11 and FIG. 12, an adapter 1a of a second embodiment of the present disclosure is similar to the first embodiment, difference mainly lies in that: the top wall portion 21a forms a group of through holes H1a (see FIG. 10) and one recessed groove 213a only at one of two sides of the top wall portion 21a. Each side wall portion 23a is only formed with one latch hole 231a (see FIG. 9). The adapter 1a only includes one cover 3a. One of two ends of the inserting passageway P11a may allow a connector 9a, which is a M D C type and an optical fiber type, to insert therein, and the other of the two ends of the inserting passageway P11a may allow a connector 9b, which is a M D C Jr. type and an optical fiber type, to insert therein. Because the adapter 1a of the second embodiment similarly includes the housing unit 2a which is a metal material and the cover 3a which is a plastic material, the second embodiment similarly may provide electromagnetic shielding while lower opportunity of abrasion or fracture the latching hook 91a of the connector 9a. The housing unit 2a is provided therein with a plurality of aligning sleeves 4. The plurality of aligning sleeves 4 are arranged so that every two aligning sleeves 4 belong to one group and are in a pair up and down. Ferrules of optical fibers of the connector 9a and ferrules of optical fibers of the connector 9b may insert into the aligning sleeves 4 from a front end and a rear end of the inserting passageway P11a so that the connector 9a and the connector 9b mate with each other. Although the second embodiment is described by the adapter 1a which allows the four pairs of connectors 9a, 9b to insert therein at the same time, in embodiments not shown, the adapter 1a also may be designed to allow one pair, two pairs or six pairs of connectors to insert therein.

In conclusion, an effect of the adapter 1 of the present disclosure lies in that: the housing unit 2 is made of a material which is capable of being conductive, and the housing unit 2 is capable of providing electromagnetic shielding protection, and the hardness of the cover 3 is lower, and the cover 3 is capable of lowering opportunity of abrasion or fracture of the latching hook 91 of each connector 9 when the adapter 1 allows the connectors 9 to insert therein.

However, the above description is only for the embodiments of the present disclosure, and it is not intended to limit the implementing scope of the present disclosure, and the simple equivalent changes and modifications made according to the claims and the contents of the specification are still included in the scope of the claims of the present disclosure.

1. An adapter, being adapted to allow at least one pair of connectors to insert therein, at least one of the connectors having a latching hook, the adapter comprising:
a housing unit made of a material which is capable of being conductive, and encircling and defining an inserting passageway and an inserting port which is communicated with the inserting passageway, the housing unit comprising an encircling wall which encircles and defines the inserting passageway and the inserting port, the inserting passageway and the inserting port being adapted to allow the connector to insert therein, the encircling wall being formed with at least one through hole which is communicated with the inserting passageway; and
at least one cover made of a material which hardness is lower than the housing unit and provided on the encircling wall of the housing unit, the cover being formed with at least one latching hole which passes through the through hole to be communicated with the inserting passageway, the latching hole being adapted to allow the latching hook of the connector to latch therewith.

2. The adapter of claim 1, wherein
the adapter is adapted to allow the multiple pairs of connectors to insert therein,
the encircling wall of the housing unit is further formed with another inserting port which is communicated with the inserting passageway, the two inserting ports are respectively positioned at two opposite ends of the inserting passageway, the inserting passageway comprises multiple inserting grooves which allow the multiple pairs of connectors to insert therein.

3. The adapter of claim 2, wherein
the encircling wall comprises a top wall portion, an outer surface of the top wall portion which backs the inserting passageway is further recessed to be formed with at least one recessed groove, the recessed groove is communicated with the through hole and allows the cover to be provided on the encircling wall of the housing unit.

4. The adapter of claim 2, wherein
the cover comprises a sheet portion and two latching arms which are provided to two opposite sides of the sheet portion,
the inserting passageway penetrates front and rear along an extending direction, the encircling wall comprises two side wall portions which are respectively positioned to two opposite sides of the inserting passageway, each side wall portion is formed with one latch hole, the two latch holes respectively allow the two latching arms to latch therein.

5. The adapter of claim 3, wherein
the encircling wall is formed with the plurality of through holes,
the cover comprises a sheet portion and multiple protruding portions which protrude downwardly from the sheet portion,
the cover is formed with the multiple latching holes, each latching hole penetrates the respective protruding portion, each protruding portion is positioned in the corresponding through hole.

6. The adapter of claim 5, wherein
the encircling wall has an inner surface which faces the inserting passageway,
a lower surface of each protruding portion is flush with the inner surface of the encircling wall.

7. The adapter of claim 5, wherein
the inserting passageway penetrates front and rear along an extending direction, the top wall portion forms an edge which is adjacent to the inserting port,
each protruding portion comprises a protruding segment which protrudes along the extending direction, each protruding segment is lower than the sheet portion, the protruding segments are positioned below the edge, the latching hook of the connector only contacts the cover and does not contact the housing unit in a process of inserting into the inserting passageway and in a process of withdrawing out from the inserting passageway.

8. The adapter of claim 2, wherein
the plurality of through holes are divided into two groups which are respectively adjacent to the two inserting ports,
the adapter comprises two covers.

9. The adapter of claim 2, wherein
the housing unit is provided therein with multiple pairs of aligning sleeves which are arranged up and down.

10. The adapter of claim 1, wherein
the housing unit is made of a metal material, the cover is made of a plastic material.

11. An assembling method of an adapter, the adapter comprising a housing unit and a cover which hardness is lower than the housing unit, the housing unit being formed with an inserting passageway, a through hole which is communicated with the inserting passageway, and an edge which is adjacent to an inserting port, the cover comprising a protruding portion, the protruding portion comprising a protruding segment, the assembling method comprising:
inserting the cover into the corresponding through hole of the housing unit by the protruding segment; and
pivoting the cover to make the cover snap into the housing unit and make the protruding segment positioned below the edge.

12. The assembling method of the adapter of claim 11, wherein
pivoting the cover by taking the protruding segment which abuts against the edge as a fulcrum to make the cover snap into the housing unit.

13. The assembling method of the adapter of claim 11, wherein
when the cover snaps into the housing unit, the protruding portion extends into the through hole of the housing unit to provide latching with a latching hook of a connector.
